(19) United States
(12) Patent Application Publication
(10) Pub. No.: US 2021/0250418 A1
(43) Pub. Date: Aug. 12, 2021

(54) Communication Device

(71) Applicant: Bayerische Motoren Werke Aktiengesellschaft, Muenchen (DE)

(72) Inventors: Abbes LAFRAOUI, Muenchen (DE); Michael NEUHAEUSER, Sankt Wolfgang (DE)

(21) Appl. No.: 17/251,610

(22) PCT Filed: Jun. 7, 2019
(86) PCT No.: PCT/EP2019/065000

§ 371 Date: Dec. 11, 2020

(30) Foreign Application Priority Data
Jun. 14, 2018 (DE) 10 2018 209 535.3

(51) Int. Cl. H04L 29/08; H04W 4/40

(52) U.S. Cl. CPC H04L 67/30; H04W 4/40

(57) ABSTRACT

A motor vehicle has a communication device on board that is configured to communicate in a wireless network on the basis of a communication profile. The communication device has a first data memory that is permanently connected to the communication device and is configured to receive at least one first communication profile and to provide a received first communication profile, and a reader for temporarily holding a second data memory configured to provide a second communication profile received therein.

### BACKGROUND AND SUMMARY OF THE INVENTION

The invention relates to technology for using a communication profile with a communication device. In particular, the invention relates to a communication device which is configured to carry out communication in a wireless network.

A motor vehicle comprises a communication device which is configured to carry out communication in a wireless network, in particular a mobile radio network. In order to be able to use a communication service in the network, it is usually necessary to have a communication profile which can comprise information such as an identifier of a user, a telephone number or an address of an offered service such as SMS or MMS. A person who is liable for communication costs can usually also be identified using the communication profile. Such a profile is also referred to as a SIM (subscriber identity module) profile and can be stored on a specific data carrier, a SIM card, in an invariable fashion. Alternatively, the SIM profile can also be loaded onto a data memory which is permanently installed in the communication device and which is also referred to as an eSIM (embedded SIM).

The communication profile is usually provided by an operator of the network. However, not every operator offers the storage of communication profiles on an eSIM. Some cell phones can be equipped with a SIM card and support a protocol called SAP (SIM Access Profile, also referred to as rSAP: remote SIM Access Profile) with which the communication profile can be provided via a local wireless Bluetooth interface. The communication device on board the motor vehicle can participate in the network using this protocol with the communication profile stored on the SIM card in the cell phone. However, SAP requires a relatively large amount of energy, with the result that an energy store of the cell phone can be stressed. More than half of the currently available cell phones do not support SAP.

An object on which the present invention is based is to provide an improved technology for facilitating the use of a communication profile which is stored on a SIM card. The invention achieves this object by means of the subject matters of the independent claims. Dependent claims present preferred embodiments.

A communication device which is configured to carry out communication in a wireless network as a function of a communication profile is provided on board a motor vehicle. In this context, the communication device comprises a first data memory which is permanently connected to the communication device and is configured to receive at least one first communication profile and to provide a first received communication profile; and a reading device for temporarily receiving a second data memory which is configured to provide a second communication profile which is received therein.

The communication device can therefore participate in the network by using the communication profile received in the second data memory, and exchange data. The described technology can be used, in particular, if an operator of the network does not provide the communication profile for the first data memory. The described technology is not limited to the use of a specific cell phone as a reading device. In particular it is not necessary for a SAP-enabled cell phone to be used. The communication profile which is received in the SIM card can therefore be used by a user in a flexible and easier fashion. In this context, the reading device does not have to be connected in a non-disconnectable fashion to the motor vehicle, as is described in more detail below.

The first data memory can comprise, in particular, an eSIM card, and the second data memory preferably comprises a SIM card. The reading device can comprise a stand-alone device which is merely configured to provide the communication profile which is received in the second data memory. In order to exchange this information, the communication device and the reading device can support a suitable communication protocol. Alternatively, the reading device can also support further functions, in particular direct participation in the network on the basis of the locally available communication profile.

The communication device can be configured to carry out communication relating to the motor vehicle by means of the first communication profile and communication relating to a user by means of the second communication profile. For example, communication whose end point comprises a component of the motor vehicle can be carried out by means of the first communication profile. Such communication can be used, for example, for an automatic emergency call in the case of an accident, for navigation information or traffic information, for telemetry or predictive maintenance data. Communication which relates to the user preferably comprises a speech channel but can also comprise the exchange of other data, for example a text, an image or a video clip, which are directed to the user as a person or originate from the user.

The communication device preferably comprises an input device for releasing the second communication profile which is received in the second data memory. The communication profile can be assigned to a user, and the user can enter a release code, also referred to as a PIN, by means of the input device. When a correct code is input the communication profile can be provided, if the code is missing or if an incorrect code is input, the provision of the communication profile can be refused. Alternatively, the input device can also be configured, for example, to scan a biometric feature of the user.

In one embodiment, the reading device is connected by means of a wire-bound interface. For example, a connection according to one of the USB standards can be provided for connecting the reading device to the communication device. The wire-bound interface can be configured to supply the reading device with electrical energy. The reading device can as a result be operated reliably and with little expenditure on maintenance.

Alternatively, the reading device is connected by means of a wireless interface. The wireless interface can be implemented according to a known standard, for example Bluetooth, WiMax or WLAN. As a result, a user of the reading device can carry the reading device on his person in an improved way and use the communication profile received in the second data memory with different communication devices. For example, a plurality of motor vehicles can be made available to the user, for example a number of family cars or a number of vehicles of a fleet of hire vehicles, and the user can use the reading device together with the second data memory in a flexible way with the communication devices of all the vehicles.

The reading device which is connected in a wireless fashion can be connected, in particular, by means of Bluetooth LE. In this context LE stands for “low energy” and characterizes a variant which requires significantly less electrical energy than a classic Bluetooth connection. The reading device can be equipped with a local energy store which then has to be charged less often. Other designations for this technology comprise BLE (Bluetooth Low Energy) or Bluetooth Smart.

In a further embodiment, the reading device is supplied with energy in a wireless fashion. For example, a charging mat, which is configured to inductively charge, for example, a cell phone on board the motor vehicle, can be used. The reading device can comprise a coil via which an electromagnetic alternating field which is provided by the charging mat can be converted into electrical energy.

In one refinement, data and electrical energy can be transferred in an interwoven fashion. For example, RFID technology or NFC technology can be used to transfer energy to the reading device by means of an electromagnetic alternating field. The reading device can transfer information by changing its electromagnetic impedance, for example. The changed impedance can bring about changed absorption of energy from the alternating field so that a current which is necessary to provide the alternating field is variable. The changes can be sensed and the transferred information extracted. In a similar way it is possible to transfer information to the reading device by modulating the strength of the alternating field.

The motor vehicle can be used in an improved way to communicate with the network without making stringent requirements of an operator of the network or of the reading device.

According to yet a further aspect of the invention, a reading device is configured to temporarily receive a data memory, wherein the data memory is configured to provide a second communication profile which is received therein. The reading device can be connected to a communication device which is configured to carry out communication in a wireless network as a function of a communication profile, wherein the connection is made by means of Bluetooth LE. In contrast to a reading device which is connected by means of classic Bluetooth, the reading device can be used in an improved way even over a relatively long time without requiring recharging of a local energy store.

In a further variant, the connection of the reading device to the communication device is possible by means of a combined wireless data and energy transmission. This can be achieved, for example, by means of RFID (Radio Frequency Identification). In this context, very different frequencies in ranges between a few kilohertz and several gigahertz can be used for the energy and data transmission. Existing components can be used in a cost-effective way for a purpose described herein.

The invention will now be described in more detail with reference to the appended drawings.

### BRIEF DESCRIPTION OF THE DRAWINGS

FIG. 1 illustrates a communication device on board a motor vehicle.

FIG. 2 is a schematic illustration of an exemplary reading device for a data memory for a communication profile.

FIG. 3 is a flow diagram of a method for providing a communication profile.

### DETAILED DESCRIPTION OF THE DRAWINGS

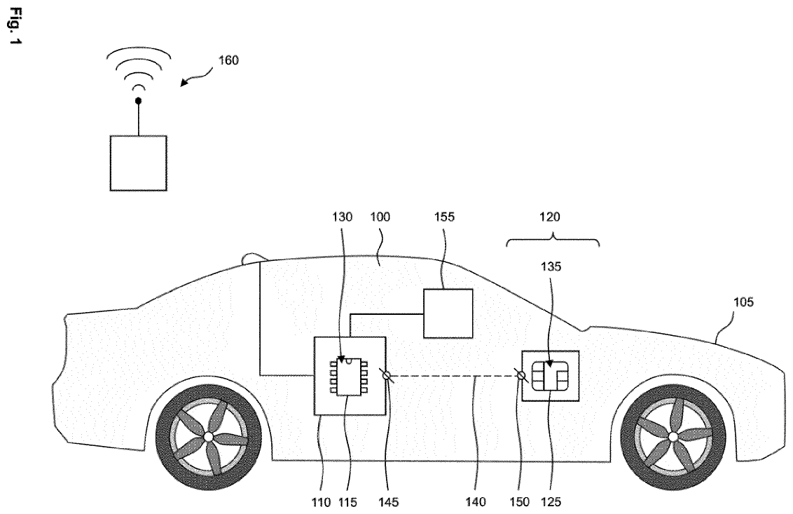

FIG. 1 shows a communication device 100 on board a motor vehicle 105. The communication device 100 usually comprises a processing device 110, also a first data memory 115 which is permanently connected to the communication device 100, and a reading device 120 which is configured to temporarily receive a second data memory 125. The data memories 115, 125 are each configured to receive a communication profile and to entirely or partially provide it to the communication device 100.

The first data memory 115 cannot be removed from the communication device 100 or the processing device 110 or be replaced within the scope of usual use. One or more first communication profiles 130 can be stored in the first data memory 115 and can then also be modified, overwritten or deleted. The first data memory 115 can comprise, in particular, an eSIM memory or an eSIM card.

The second data memory 125 can, for example, be inserted by a user into the reading device 120 or removed from it. The second data memory 125 can be embodied, in particular, as a SIM card. A connection between the reading device 120 and the second data memory 125 generally comprises at least one electrical contact; usually six contact faces are formed on the reading device 120 and the second data memory 125 correspondingly has a large number of mating contacts. Different sizes of SIM cards can optionally be supported, for example SIM, mini-SIM, micro-SIM and/or nano-SIM. In a further embodiment, the reading device 120 is configured to receive a plurality of second data memories 125 simultaneously.

A connection 140 between the reading device 120 and the communication device 100 or the processing device 110 is embodied in a wire-bound fashion in a first embodiment and can, in particular, comprise a data channel for transferring information and an energy channel for supplying the reading device 120 with electrical energy. For example, the connection 140 can be embodied according to one of the USB standards. A first interface 145 and the reading device 120 on the communication device 100 or the processing device 110 can have a second interface 150 which can be connected by means of a suitable cable.

In a second embodiment, the connection 140 is embodied in a wireless fashion, wherein the interfaces 145, 150 are correspondingly embodied as transmitters or receivers. The wireless connection 140 can be constructed, for example, according to a WLAN or Bluetooth standard. The connection 140 is particularly preferably embodied according to the Bluetooth LE Standard, which is usually specified for transmissions over distances less than approximately 10 m and can require only modest power consumption, in particular on the part of the reading device 120, both during operation and in the standby mode. The reading device 120 can have a local energy store for supplying energy.

An energy store of the reading device 120 can be occasionally charged by means of a known wire-bound charging device. Alternatively, a wireless charger can be provided which can transmit electrical energy to the charging device 120, in particular by means of an electromagnetic alternating field. In yet a further embodiment, the wireless data transmission and the wireless energy transmission are embodied combined with one another, for example according to an RFID standard.

The charging device 120 can be mounted on the motor vehicle 105 or can operate independently of the motor vehicle 105. In one embodiment, the reading device 120 can be moved freely. A user can move the reading device 120 actively, and the reading device 120 can be attached to the user's body or to a movable object such as a cell phone or a key. If a wireless connection 140 is provided, a data connection can be established automatically when the interfaces 145 and 150 are in range with one another.

The communication device 100 can comprise an input device 155 for the user. By means of the input device 155, the user can control, for example, the establishment of the connection 140 or the release of the second communication profile 135. In particular, the user can input, by means of the input device 155, a code or PIN which is necessary to unblock the second communication profile 135. The PIN can be transferred to the reading device 120 and into the second data memory 125 by means of a customary exchange protocol via the connection 140.

The communication device 100 can also comprise other elements, not all of which are illustrated in FIG. 1. For example, an antenna 160 for emitting or receiving wireless information is usually provided. The antenna 160 can be connected to a transceiver device and the latter can be connected to a modem for converting data into analog signals and back. For the sake of simpler illustration it is assumed that such elements are included in the processing device 110.

The communication device 100 is configured to carry out communication in a wireless network 160, of which only one transceiver station is illustrated by way of example. An operator of the network 160 or part thereof permits communication in the network 160 by providing communication profiles 130, 135.

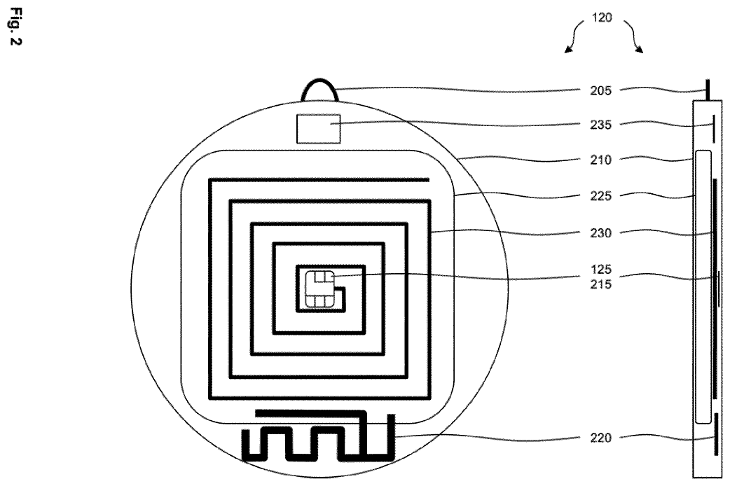

FIG. 2 shows a schematic illustration of an exemplary reading device 120 for a second data memory 125 for the second communication profile 135. A cross section is illustrated in the left-hand area, and a longitudinal section is illustrated in the right-hand area. The reading device 120 can be of compact design and be, for example, of the size of a coin. A flat cylindrical shape is selected by way of example even though virtually any other shapes are also possible. The reading device 120 optionally comprises an eyelet 205 for attachment, for example, as a key fob to a bunch of keys.

The reading device 120 comprises a housing 210 and a receptacle 215 for the second data memory 125. In the illustrated embodiment, the connection 140 is wireless, and the second interface 150 comprises an antenna 220. An energy store 225 can be provided for the supply of energy. In order to charge the energy store 225, it is possible to include a suitable electrical plug-type connection or a coil 230 which is configured to provide electrical energy from an electromagnetic alternating field.

In a further embodiment, the energy store 225 is dispensed with and the energy supply is provided directly by means of the coil 230. In yet a further embodiment, the antenna 220 is dispensed with and the data transmission is provided by means of modulation of the alternating field which is applied to the coil 230. In order to control processes in the reading device 120, a processing device 235 can be provided. Electrical connections within the reading device 120 are not illustrated in FIG. 120.

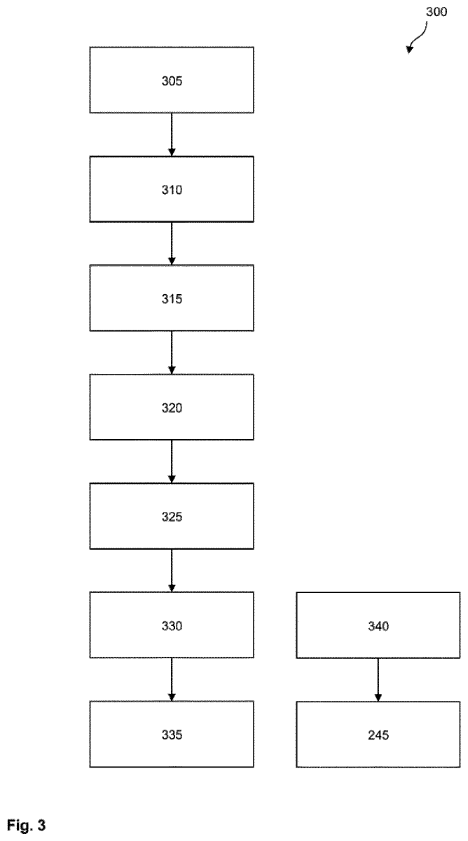

FIG. 3 shows a flow diagram of a method 300 for providing a second communication profile 135. The method 300 can be carried out, in particular, by means of a communication device 100. Parts of the method 300 can be implemented, in particular, by means of the processing device 110 and/or the processing device 235. For this purpose, one of the processing devices can comprise a programmable microcomputer or microcontroller, and the method 300 can be present in the form of a computer program product with program code means. The computer program product can also be stored on a computer-readable data carrier. Features or advantages of the method which are specified herein can be transferred to the communication device 100 or the reading device 120, or vice versa.

By way of example, a wireless connection 140 will be assumed; a relevant person skilled in the art can easily convert the method 300 for the use of a wire-bound connection 140. In a step 305, the second data memory 125 can be inserted—for example in the form of a SIM card—into the reading device 120. If the reading device 120 has an energy store 225, it can be charged. In a step 310, the reading device 120 comes within range of the communication device 100 and, in a step 315, a first data exchange can take place between the communication device 100 and the reading device 120. The data exchange can serve to prepare or request the inputting of a code or of a PIN which can be necessary to release the second communication profile 135 which is stored in the second data memory 125.

In a step 320, the user can input the PIN by means of the input device 155, and the second communication profile 125 can be unblocked by means of the PIN. The second communication profile 125 can be provided to the communication device 100 in a step 325. After this step 325 is carried out, a data transmission can be made possible between the network 160 and the communication device 100 using the second communication profile 135. A data transmission can comprise incoming or outgoing data or an incoming or outgoing connection.

In a step 330, a communication enquiry, which is preferably assigned to the second communication profile 135, can be determined. Another communication enquiry, which is assigned to the first communication profile 130 and is stored in the first data memory 110 of the communication device 100, is not considered further here. The communication enquiry can originate from the user or from a terminal of the network 160. The communication device 100 can subsequently communicate, in a step 335, with the network 160 or one of its terminals using the second communication profile 135.

In a step 340, the reading device 120 may move out of range of the communication device 100, so that the connection 140 becomes unreliable or is lost entirely. Communication is then usually still possible for a predetermined time; however, after this time, for example approximately seven seconds, the communication is usually ended. The communication can be resumed if the connection 140 is re-established. This function is usually a component of a communication method between the communication device 100 and the network 160.

### REFERENCE NUMBERS

100 Communication device

105 Motor vehicle

110 Processing device

115 First data memory

120 Reading device

125 Second data memory

130 First communication profile

135 Second communication profile

140 Connection

145 First interface

150 Second interface

155 Input device

160 Network

205 Eyelet

210 Housing

215 Receptacle

220 Antenna

225 Energy store

300 Method

305 Insertion of SIM card into reading device

310 Reading device enters range of the communication device

315 Data exchange

320 Inputting of PIN, unblocking

325 Provision of communication profile

330 Determination of communication enquiry

335 Communication with communication profile

340 Reading device moves out of range of the communication device

345 Terminate communication

1.-11. (canceled)

12. A communication device on board a motor vehicle, wherein the communication device is configured to carry out communication in a wireless network as a function of a communication profile, comprising:
a first data memory permanently connected to the communication device and configured to receive at least one first communication profile and to provide a first received communication profile; and
a reading device for temporarily receiving a second data memory which is configured to provide a second communication profile which is received therein.

13. The communication device according to claim 12, wherein
the communication device is configured to carry out communication relating to the motor vehicle by way of the first communication profile and communication relating to a user by way of the second communication profile.

14. The communication device according to claim 12, wherein
an input device is provided for releasing the second communication profile which is received in the second data memory.

15. The communication device according to claim 12, wherein
the reading device is connected by way of a wire-bound interface, and the wire-bound interface is configured to supply the reading device with electrical energy.

16. The communication device according to claim 12, wherein
the reading device is connected by way of a wireless interface.

17. The communication device according to claim 16, wherein
the reading device is connected via Bluetooth LE.

18. The communication device according to claim 17, wherein
the reading device is supplied with energy in a wireless fashion.

19. The communication device according to claim 16, wherein
the reading device is supplied with energy in a wireless fashion.

20. The communication device according to claim 18, wherein data and electrical energy are transferred in an interwoven fashion.

21. A motor vehicle comprising a communication device according to claim 12.

22. A reading device for temporarily receiving a data memory, wherein
the data memory is configured to provide a second communication profile which is received therein,
the reading device is connectable to a communication device which is configured to carry out communication in a wireless network as a function of a communication profile, and
the connection is made via Bluetooth LE.

23. A reading device for temporarily receiving a data memory, wherein
the data memory is configured to provide a second communication profile which is received therein,
the reading device is connectable to a communication device which is configured to carry out communication in a wireless network as a function of a communication profile, and
the connection is made by way of a combined wireless data and energy transmission.
